(19) United States
(12) Patent Application Publication
(10) Pub. No.: US 2011/0213733 A1
(43) Pub. Date: Sep. 1, 2011

(54) System and method for grading and rating green and sustainable jobs

(76) Inventor: Dennis Ray Cail, II, Dallas, TX (US)

(21) Appl. No.: 12/660,428

(22) Filed: Feb. 26, 2010

(51) Int. Cl. G06Q 90/00

(52) U.S. Cl. 705/500

(57) ABSTRACT

A system and method for lowering carbon emissions in the workplace by assigning green job scores for job seekers and entities based on job classifications, job requirements, job responsibilities, job time evaluation, efficiency units, renewable units etc., in the performance of their tasks to sustain and renew energy in the work place. Employers seeking to fill job vacancies are assigned a green job score by the system for each job based on job category and seek and hire applicants with resume attributes that match the green score requirements. The system and method uses renewable units, keyword method, and a green job grading module, to scan, search, and evaluate a job applicant's resume to generate a green job score based on the applicants job history. In this embodiment, the job seeker can use the job seeker's dashboard to view green ratings for jobs listed by employers and aggregated percentages by job classification, companies, departments, city, state, country, and zip code.

### FIELD OF THE INVENTION

This invention relates generally to carbon emissions from human activity in the work place. More particularly, the invention relates to green and sustainable grading and rating of jobs, employees, and job seekers based on work history, personal biography, work place activity, and the utilization and conservation of energy during the process of performing work according to job descriptions and requirements.

### BACKGROUND OF THE INVENTION

Human activity of various kind including activities carried out in the workplace have steadily increased the concentration of carbon dioxide (CO₂) and other green house gases since the dawn of the industrial era. Although the concentration of CO₂ from natural sources is much higher than that generated by human activity, more recently, the increase in human activity related to burning of fossil fuels and deforestation have seen a concomitant spike in the total anthropogenic carbon emissions. To a lesser extent, the generation of CO₂ through everyday personal human activity whether at home or at work contributes to the total CO₂ emissions and the green house effect.

The process of generating electricity is the single largest source of CO₂ emissions in the United States representing about 41% of CO₂ emissions. This means that increased use of electricity for everyday human activity leads to increased demands for the generation of electricity which in turn leads to increased CO₂ emissions from electricity generation. Optimizing the operational efficiency and reducing the costs of major energy consuming systems in large facilities as described in U.S. Pat. No. 6,366,889 has received a great deal of attention in recent years as a means to conserve energy. However, analyzing carbon emissions and the carbon footprint of industrial, commercial and governmental facilities have not received the same attention they deserve if the ultimate goal besides energy conservation is to reduce carbon emissions and global warming.

One source of electricity usage and CO₂ generation is in the work place where most people spend a majority of their waking hours. All jobs are responsible for emitting some level of Co₂ into the atmosphere as a result of the expenditure of energy to make a product or provide a service. Although much emphasis has been placed on the conservation and utilization of energy at the job level in the work environment by some of the large and small organizations and industries, an analysis and evaluation of the carbon emissions in these work environments related to job requirements, job responsibilities, efficiency in the completion of tasks and other parameters has not received the attention it deserves given that carbon emissions generated in the work place due to job related tasks is a critical component of the overall Co₂ generation and contribution to the green house gas effect and global warming. It is self evident that the energy expended at the work place by for example an architect or computer programmer is measurably lower than a welder or a mechanic. However, the energy expended by individual workers in the same profession may vary depending on the specific job responsibilities and tasks performed and the efficiency with which the tasks are performed to fulfill the job requirements. The same applies to industries where the energy expenditure and thus the carbon emissions for an industry will depend on the job and task requirements for the workers in that industry besides the energy expenditure through operation of machinery particular to that industry. There is currently no system in place in work environments where employees are graded on how efficiently they execute their tasks to reduce the use of electricity and other forms of energy and be given a green job score which is taken into consideration along with other carbon performance criteria when evaluating the company's overall carbon emissions and carbon footprint.

The job-related systems and applications to date have focused mainly on individual work effectiveness through performance analysis and monetary compensation based on productivity. Systems and methods for evaluating and rating employees based on job performance are well known in the art. U.S. Pat. Appl. No. 2007/0244743 describes a system and method for evaluating and rating employee performance based on job objectives. Various parameters have also been used to determine an individual's work effectiveness on a particular job. U.S. Pat. Appl. No. 2009/0234719 has devised a method to evaluate the work effectiveness of an individual for a given event to determine if that individual can continue to work after a certain point when fatigue takes over. U.S. Pat. Appl. No. 2010/0004983 refers to a performance management system and method to evaluate service administrators at a call center based on among other criteria, the quickness in correcting service orders, how many orders were processed etc. U.S. Pat. No. 7,596,507 focuses on a system and method for accelerated performance in the work place by creating a score card for analyzing the correlation between a time study data and performance data and generating and implementing a road map for resolving an issue. The system and method of the present invention evaluates employee performance not only based on the various parameters used in the prior art, but also based on a green job score card generated taking into consideration efficiency and time management in the execution of the tasks required to complete the job according to job requirements and job responsibilities.

Currently, the benchmarks and tools used to analyze the performance of an individual or entity do not take into consideration a green job score rating as the present invention does. U.S. Pat. Appl. No. 2010/0030722 discusses a method for measuring performance of an entity based on social dynamics information such as network coefficients for team members and contributors, weighting the types of ties between team members and contributors and generating a social dynamic score and a competitive relationship score based on a few other parameters. U.S. Pat. Appl. No. 2009/0313093 describes a method for obtaining a greenness metric for a plurality of services based on power consumption, location and carbon offset utilization and comprising querying a service provider and a third party for the greenness metric for each of the plurality of services. However, this prior art does not analyze the carbon emissions generated by particular individuals based on their job responsibilities and the efficiency with which they complete particular tasks in the work environment to generate a green job score for each employee, job seeker and the industry.

Part of a job being green is how efficiently an employee can perform the job based on the average time it takes to complete a said task. If an employee can complete a task in less time than it would take an average person to complete the same task, then that employee is essentially helping that job and company become more energy efficient. Likewise, if an employee completes a task in the process of making a product or providing a service, then that job being performed by that employee is essentially responsible for a percentage of carbon emission emitted as a result of that employee performing their job while making a product or providing a service. This information is not being captured and used today to garner green job and carbon job ratings. There is currently no system in place that offers a green job grade or score based on job requirements, job responsibilities and efficiency in completing tasks or activities of particular jobs

Job matching and employee hiring systems and methods based on various parameters are well known in the art. U.S. Pat. Appl. No. 2009/0210281 matches employment candidates to employment positions based on measures of personality traits derived from administering a set of questionnaires. U.S. Pat. No. 7,437,309 describes a human capital management system that collects position skills, past performance, and future requirements information from a combination of job applicants, employees and reserve pool talent with the search results being scored and ranked to return a list of candidates for a defined position which is then subjected to managerial review. U.S. Pat. No. 7,191,139 is directed to a method and apparatus for cataloging, inventorying, selecting, measuring, valuing, and matching Intellectual Capital skills with the aim of finding candidates for an employment or consulting position and creating a searchable knowledge base of individual skills indexed in a hierarchical cataloging, measuring and valuation system. U.S. Pat. No. 7,457,764 describes a system for matching entities having needs to entities having capability to meet the needs by creating a plurality of needs profiles and capability profiles, identified and matched through a matching engine. None of the prior art to date have addressed the issue of matching job seekers to jobs and entities with a focus on energy efficiency in the performance of tasks related to job requirements and job responsibilities.

The present invention provides a system and method to match job seekers with employers who are seeking to hire job applicants based on their green job scores and/or efficiency in completing tasks to conserve energy in the work place to reduce carbon emissions and a reduced carbon foot print for the entity. A job seeker can use a green job score rating they receive based on their work history, job qualifications, job requirements, responsibilities and tasks performed in their resumes to market themselves when pursuing job opportunities. The system and method of the present invention thus creates a new breed of “green collar job” workers. Corporations, organizations and other such entities in turn will have an opportunity to hire green collar job workers by screening job applicants based on their green job scores Hiring job applicants who have high green job scores will bring in a more efficient, energy saving goal oriented work force that will be cost effective for the hiring entity while at the same time lead to lower CO₂ emissions and a reduced carbon foot print for the entity and environment. Entities can essentially use this information to make key organizational changes based on these green job scores that will ultimately benefit the organization and the environment. Corporations, organizations and other entities can also be given a green job score rating based on their jobs, job requirements, job classifications and hiring of job applicants with high green job scores

The present invention fulfills the deficiencies in the prior art and the systems and methods currently in place for grading and evaluating individual, entity, and industry performance by including the need for a carbon foot print performance analysis through a green job score rating system and method.

### SUMMARY OF THE INVENTION

It is an objective of the present invention to provide a system and method to grade the green performance of individuals and entities based on job classifications, job requirements, job qualifications, work history, job performance, energy utilization and energy conservation associated with the work or job performed in order to rate and reduce the anthropogenic workplace related carbon emissions. The system and method of the present invention enhances the measurement and management of an entities overall carbon footprint using dashboard and reporting tools to view, manage, import and extract green job score data. The system and method can then be used to determine Renewable Energy Credits (REC).

Another objective of the present invention is to provide a system, method, and storage device that allows employers to provide a green score rating for their filled and vacant jobs based on qualifications and requirements.

Another objective of the present invention is provide a system, method and storage device that allows job seekers to receive a green work history score based on their resume, qualifications and job profile. In a preferred embodiment of the present invention, the system and method provides a green job score to an employee or job seeker based on qualifications, job requirements, job responsibilities, job time evaluation, skills, and efficiency in the performance of their tasks to sustain and renew energy. In this embodiment, employers seeking to fill job vacancies assign a green job score for each job based on renewable units, efficiency units and job requirements, to seek and hire applicants with resume attributes that match the green job score requirements. This embodiment uses a keyword method and green job grading module to scan, search and find keywords in a job applicant's resume to generate a green job score based on the applicants work history. In this embodiment, the job applicant can use the job seeker's dashboard, view green ratings for jobs listed by employers and aggregate percentages by job classification, companies, departments, city, state, country and zip code.

In an exemplary embodiment of the present invention, the system and method establishes a green job score rating scale for the job seeker or employee based on their job profile, work history and resume to generate the green job score. In this embodiment, the employee or job seeker receives a system generated green job score based on their job profile, work history or resume. In this embodiment, the system and method is intelligent enough to scan the job profile, work history and resume of a job seeker or employee and understand all the words, phrases and numbers to determine a green job score for the job seeker or employee. In this embodiment scores can be added to the job profile, resume and/or user account for review by employees, potential job seekers, employers, and recruiters. In this embodiment the green job score can be included in the entity's overall green score or carbon footprint.

In yet another exemplary embodiment of the present invention, the system and method generates a green jobs map and dashboard that illustrates which geographies, communities, cities, states, countries, regions, markets, companies, organizations and industries have the most and least green jobs based on volumes, scores, percentages, gains, losses and per capita. In a related embodiment, the green jobs map and dash board are generated illustrating the categories mentioned based on aggregated green job scores.

In an embodiment of the present invention, the system and method provides for a carbon efficiency/audit system that is linked to and/or integrated with the company's back-office system to determine what products, services, functions and/or business processes contribute to the job's overall rating. The green job score rating/grading system is integrated with back office applications or other software systems, time keeping systems, travel management systems, material management systems, logistics systems, project systems, sales and distribution systems, human resource systems, e-Recruitment systems, performance appraisal systems, wireless system, SaaS system, cloud computing system, third party systems and other back office systems and business processes to calculate and report green job scores based on actual work performed, job function, job category, job requirements, job qualifications and job activity. Collected and stored data can also be used to determine new standards and baselines based on averages and trends over time.

In another embodiment of the present invention, the system and method provides a green job classification system and green job score based on the environmental impact of each job based on aggregated data across systems, organizations, companies and countries.

In another embodiment of the present invention, the system and method provides a green job classification score based on geography that rates the social impact of each job based on the green job score in said geographical area. In a related embodiment, the green job classification and geography green job score rates internal or external projects based on the direct and indirect jobs associated with the project. In this embodiment projects are graded and rated based on aggregated green job scores.

In another embodiment of the present invention, the system and method provides a job classification method and economic score that rates the financial impact of each job with respect to reducing or not reducing carbon emissions.

In another embodiment of the present invention, the system and method provides a job classification system and market score that rates the market or industry impact of each job based on the aggregated green job scores in that industry.

In another embodiment of the present invention, the carbon footprint of jobs are graded and reclassified with green job score based on federal job classification standards, including occupational groups, allowing all jobs to be reclassified with green job score.

The green job scoring and rating method of the present invention provides an easy to use system for assisting companies and job seekers in grading how green their jobs are based on the requirements, responsibilities, work history and performed tasks. No longer are job seekers simply evaluated on how well they interview or complete a task, but also on how efficiently the task is completed to conserve energy. Upon appropriate entries, upload, or activity, the system returns the results to provide a green job score for an employee or job seeker that can be readily accessed by an employer or recruiter. This system and method can be used by government agencies, municipalities, NGO's, companies, non-profit organizations, recruiters, and employers to hire job seekers with high green job scores.

These and other embodiments, features, advantages, and objectives of the present invention will become obvious to one skilled in the art through the drawings, detailed description of the invention, and the appended claims.

### BRIEF DESCRIPTION OF THE DRAWINGS

FIG. 1 illustrates an overview of an exemplary embodiment of the present invention.

FIG. 2 illustrates the creation of job seeker and/or job profiles and generation of a green job score result, resume Id, job Id employer Id, and job seeker Id.

FIG. 3 is a flow chart of the exemplary embodiment of the present invention showing the generation of the green job score result starting with a coarse rating and calculating the green scores based on particular algorithms as well as the generation of a Renewable Energy Credit (REC) based on the green job score results.

FIG. 4 is a flow chart showing an embodiment of the present invention used to generate a green job score based on tasks performed on a particular job.

### DETAILED DESCRIPTION OF THE INVENTION

The present invention relates to a system and method to grade the green performance of individuals and entities based on job classifications, job requirements, job qualifications, job/work history, job performance, energy utilization and energy conservation associated with the work or job performed in order to reduce the anthropogenic workplace related carbon emissions. The present invention focuses on a system and method to measure, manage, and reduce carbon emissions in the workplace by assigning green job scores based on job category, job classification, job requirements, job profile, job qualifications, work history and job time keeping and evaluation in executing the tasks required for job completion. Another goal of the invention is to recruit and retain job applicants and employees who have high green job scores as well as allow job seekers to seek and secure jobs with companies that offer jobs with higher green job scores. An additional goal of the invention is to provide a green job score that can be used in the entities overall calculation for Renewable Energy Credits (REC). The system and method of the present invention enhances the measurement and management of an entities overall carbon footprint using dashboard and reporting tools to view, manage, import and extract green job score data. The system and method can then be used to determine Renewable Energy Credits (REC).

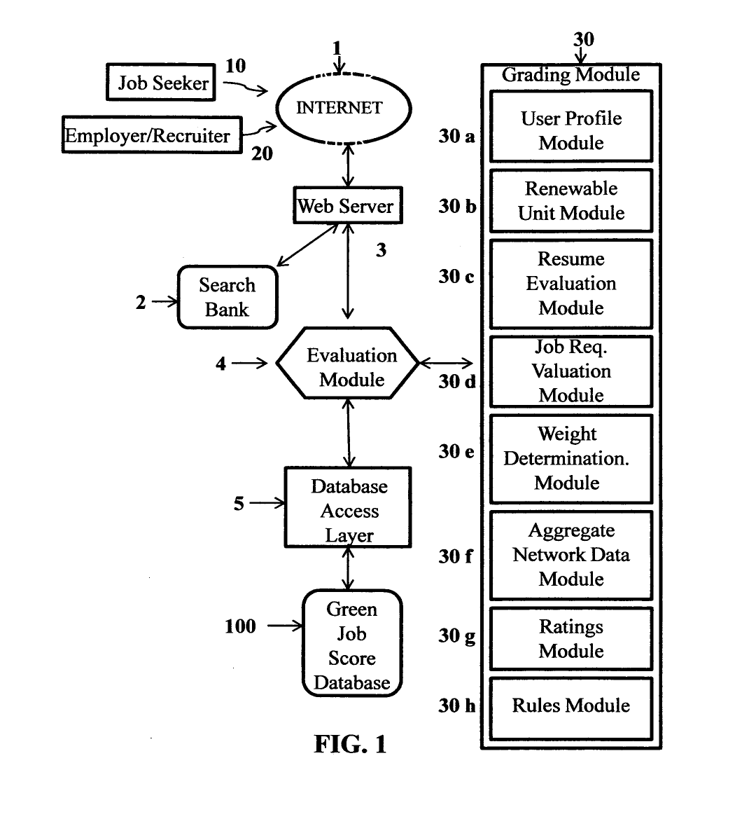

Referring now to FIG. 1, an overview of an exemplary embodiment of the present invention is illustrated showing the inter-relationship between the various systems and modules and the steps involved in the generation of a database 100 with job seeker profiles that match with job requirement profiles based on green job scores and ratings. The job seeker 10 accesses the interne 1 through a web server 2 and through the job seeker's dashboard connected to a search bank 3, views green rating for jobs listed by employers and aggregated percentages by job classification, companies, departments, city, state, country, and zip code. The job seeker's profile and the selected job profile are entered into the evaluation module 4 which is connected to the grading module 30 which comprises various algorithm modules such as, 30 a user profile module, 30 b renewable unit module, 30 c resume valuation module, 30 d job requirements valuation module, 30 e weight determination module, 30 f aggregate network data module, 30 g ratings module, and 30 h rules module. This exemplary embodiment of the present invention uses the green job grading module 30 to scan and search a job seeker's profile and resume and match it with the job requirements which is then delivered to the evaluation module 4 for generating a green job score rating for the job seeker based on the job seeker's profile, job history and resume. The green job score for the job seeker generated by the evaluation module 4 through the grading module 30 is stored in a database 100 that is accessible by employers/recruiters 20 as well as the job seeker, 10 through the database access layer 5.

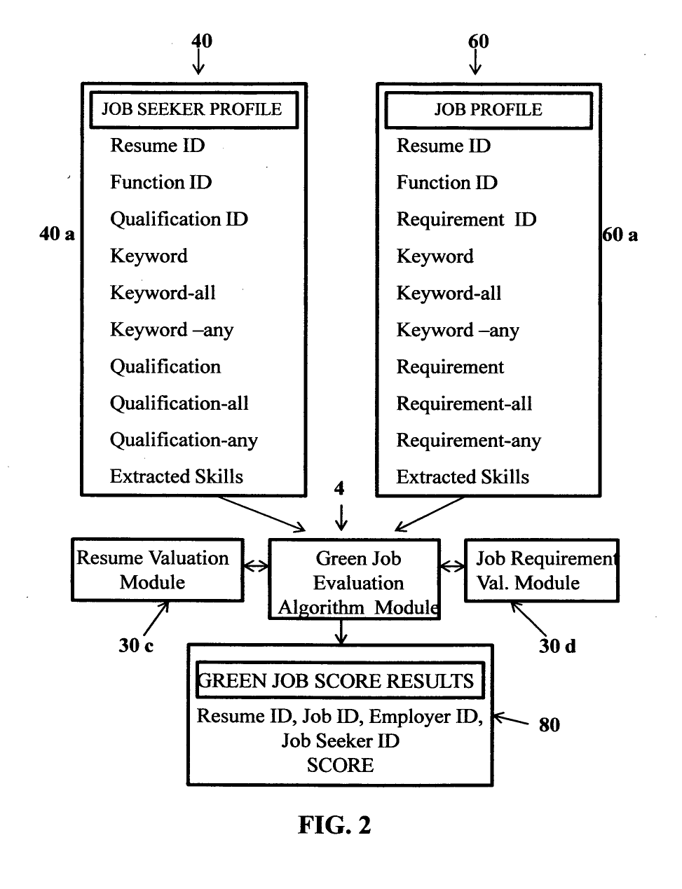

FIG. 2 illustrates the steps involved in the creation of a job seeker profile 40 and a job profile 60 using the recited algorithms in the modules, 40 a and 60 a respectively. In this embodiment, the job seeker using key words, qualifications, job functions, skills, and resume creates a job seeker profile 40 and the employer using another set of key words, job requirements, job description, job functions, required skills, creates a job profile 60. The aggregate of the job seeker profile 40 and the aggregate of the job profile 60 are entered into the green job evaluation algorithm module 4 which uses the criteria from the resume valuation module 30 c and the job requirement valuation module 30 d to generate the green job score results 80 for both the job seeker and the employer.

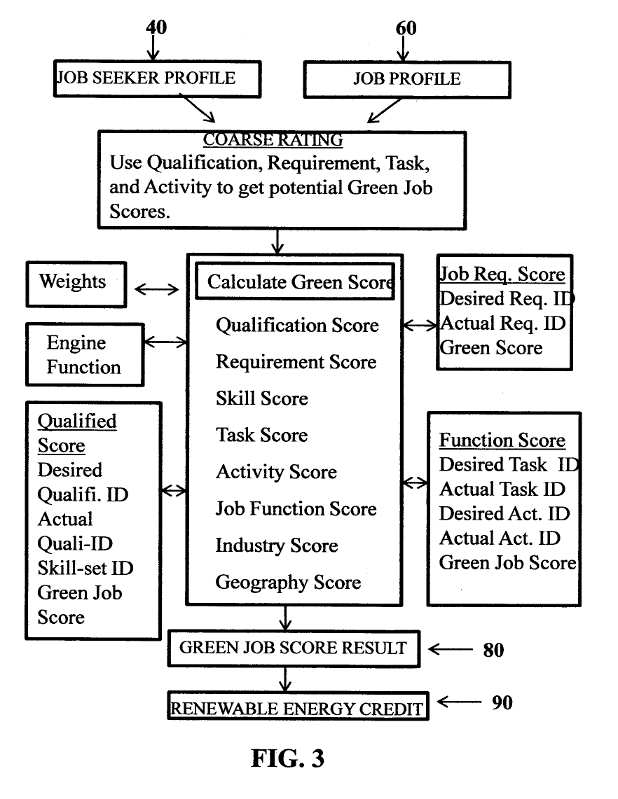

FIG. 3 is a flow chart of the exemplary embodiment of the present invention showing the generation of the green job score result starting with a coarse rating and calculating the green job scores based on particular algorithms relating to the job seeker profile 40 and the job profile 60. In this embodiment of the invention, the green job score results 80 are used to calculate and generate Renewable Energy Credits (REC) 90 for the entity

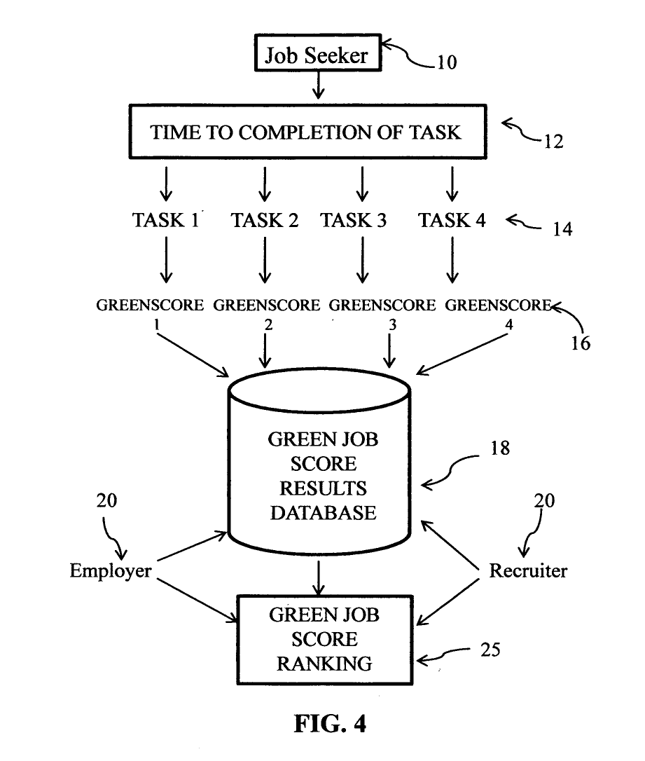

FIG. 4 shows a flow chart for another embodiment of the system and method for grading an employee based on the current invention. Job seeker 10 logs into a computer at his work place and accesses the web page uploaded with the software for the system and method of the present invention. He/she enters the time to completion 12 for a set of tasks 14 required in his/her job description. The time to completion 12 for each task 14 is entered separately to generate a green score 16 for that particular task. The aggregate of the green scores 16 are entered into a green job score results data base 18 that stores the green job grade score of that employee. The green job score results data base 18 is accessible by the employee 10, employer 20 and also selectively made available to recruiters 20 who are scouting for talent in that particular industry or sector. The green job score results data base 18 periodically generates a set of green job score rankings 25 for each employee 10 accessible by the employee, the employer 20 and the recruiter(s) 20.

In another embodiment of the present invention, applicants for jobs with an employer who practices the green job scoring system and whose criteria for hiring is based on applicants having a green job score and ranking, are required to answer a set of green job score rating questionnaires when applying for positions with the entity. The answers to the set of questionnaires generates a green job score rating for the job applicant along with his/her work history and resume to generate a weighted average which is evaluated and taken into consideration when the employer makes the hiring decision.

The system and method of the present invention, provides incentives to employees and job seekers to strive towards a high green job score rating milestone at work and when applying for jobs. This in turn, helps in lowering carbon emissions and a greener environment in the workplace. The system and method of the present invention also provides for the demotion or discharge of employees who do not meet a threshold of green job scores during a work cycle.

The practice of grading jobs and entities based on green job scores as embodied in the system and method of the present invention creates green rated and green ranked companies and organizations that set an example and incentive for other entities to also go green and reduce the carbon footprint in the environment. The system and method of the present invention also makes it possible for government agencies, municipalities, NGO's, and others to measure the impact of green job rated companies, organizations and other entities on the environment as compared to others who do not practice the green job score rating method and system.

The foregoing description of the invention through its figures and preferred embodiments should not be construed to limit the scope of the invention. It should be understood and obvious to one skilled in the art that the embodiments of the invention thus described may be further modified without departing from the spirit and scope of the invention as set forth in the claims that follow.

What is claimed is:

1. A method for evaluating a job seeker, employee, or entity based on conserving energy and reducing carbon emissions in the workplace comprising the steps of:
a) assigning a green job score for a job seeker based on a set of pre-determined algorithm defining a job seeker profile;
b) assigning a green job score for an employer based on a set of pre-determined algorithm defining a job profile;
c) generating an aggregate green job score result by evaluating and combining the green job score of the job seeker profile and employer job profile; and
d) establishing a green job score data base.

2. A method as in claim 1 wherein, the said algorithm for the said job seeker profile and said job profile are derived from, job qualifications, job classifications, job requirements, job responsibilities, job time evaluation, efficiency units, renewable units and similar parameters.

3. A method as in claim 1 wherein, the said job seeker profile is created using keywords, definitions, qualifications, job functions, skills, and resume.

4. A method as in claim 1 wherein, the said job profile is created using key words, definitions, job requirements, job description, job functions, and required skills.

5. A method as in claim 1 wherein, the said green job score results generated through the said job seeker profiles and said job profiles are used in the selection of candidates for a job.

6. A method as in claim 1 further comprising the step of generating a renewable energy credit for the said entity based on the green job score results for that entity.

7. A system for evaluating and selecting job seekers based on conserving energy and reducing carbon emissions in the work place comprising;
a) means for assigning a green job score for a job seeker through the creation of a job seeker profile based on, job qualifications, job responsibilities, job time evaluations, skills, work history, and resume;
b) means for assigning a green job score for an employer through the creation of a job profile based on job requirements, job description, job functions, required skills, efficiency units, and renewable units; and
c) means for matching the job seeker profile with the job profile based on green job score results.

8. A method for selecting a candidate for a job from a pool of job seekers comprising:
screening job seekers with high green job scores;
said green job scores generated through a set of grading modules based on job qualifications, job responsibilities, job time evaluations, skills, work history, and resume; and
matching said green job scores generated through job seeker profiles with job profiles based on job requirements, job description, job functions, required skills, efficiency units and renewable units.
